(19) United States
(12) Patent Application Publication
(10) Pub. No.: US 2004/0131873 A1
(43) Pub. Date: Jul. 8, 2004

(54) Pressure sensitive adhesive composition containing ethylene/vinyl ester functional copolymers having high ethylene content

(76) Inventors: Jiangbo Ouyang, Flemington, NJ (US); Donald R. Williams, Newtown, PA (US); Rama S. Chandran, Bridgewater, NJ (US)

Correspondence Address: Thomas F. Roland, NATIONAL STARCH AND CHEMICAL COMPANY, P.O. Box 6500, Bridgewater, NJ, 08807-0500, US

(21) Appl. No.: 10/338,952

(22) Filed: Jan. 8, 2003

(51) Int. Cl. C08L 31/02

(52) U.S. Cl. 428/507; 524/543; 524/563

(57) ABSTRACT

The present invention is directed to a pressure sensitive adhesive (PSA) composition containing a copolymer of a vinyl ester and ethylene, formed by emulsion polymerization. The ethylene level of the copolymer is from 40 to 75 weight percent. The copolymer is free of carboxyl-functional monomer units. The copolymer preferably also contains a non-carboxyl functional monomer. The PSA is useful for labels, decals, repositionable notes, and different types of tape. Labels containing the PSA adhere especially well to non-polar substrates.

### FIELD OF THE INVENTION

The present invention relates a pressure sensitive adhesive composition containing a copolymer of a vinyl ester monomer, ethylene, and a non-carboxyl functional monomer. The copolymer is formed by emulsion polymerization and contains between 40 and 75 percent by weight of ethylene. The copolymer is free of carboxyl-functional monomers.

### BACKGROUND OF THE INVENTION

Pressure sensitive adhesive (PSA) compositions are known in the art to be useful in removable, repositionable, permanent label, and tape adhesive applications. These adhesive compositions must have good dry tack to instantaneously adhere to a substrate with minimal pressure. They must also exhibit good peel, tack, and shear properties. Many PSA compositions are formed in solvent processes. Recently, environmentally friendly aqueous-based processes have been used to produce the adhesives. Currently, acrylic emulsions dominate the water-borne PSA market.

Ethylene-vinyl acetate (EVA) emulsion copolymers are known in adhesive applications. To improve performance properties, EVA adhesives may be modified through the use of functional monomers. U.S. Pat. No. 5,3119,027 describes a miscible blend of an ethylene/vinyl acetate (EVA) copolymer with an acrylic acid copolymer. Acetoacetyl functionality and carboxyl functionality have been copolymerized into an EVA for improved adhesive properties, as described in U.S. Pat. Nos. 5,665,816, and 5,569,703.

EVA pressure sensitive adhesive emulsions normally lack the dry tack and cohesive strength of solvent-based PSAs. These properties have been improved through the incorporation of functional monomers, such as carboxyl, (meth)acrylamide, and methylol containing monomers into the EVA, as described in U.S. Pat. Nos. 4,128,518; 4,322,516; and 5,276,084. Each of these EVA copolymers contains from 5 to 40 percent by weight of ethylene.

Ethylene is an economical monomer. Incorporation of higher levels of ethylene into the copolymer can result in a lower cost product. High ethylene EVA pressure sensitive adhesives having carboxyl functionality are described in U.S. Pat. No. 6,319,978. The level of ethylene in the copolymer is between 45 and 65 percent, preferably from 45 to 55 percent by weight. A process for producing high ethylene EVA emulsions is described in U.S. Ser. No. 09/823,318 Patent Application incorporated herein by reference.

There is a need for a high ethylene EVA composition that is useful as a pressure sensitive adhesive, and has performance improvements over the current technology.

Surprisingly, it has been found that ethylene/vinyl ester emulsions having from 40 to 75 percent by weight of ethylene, and no carboxyl functionality make good pressure sensitive adhesives. The ethylene/vinyl ester copolymer, and especially EVA copolymer, preferably contains, functionalized non-carboxyl monomers which produce pressure sensitive adhesives having excellent properties. The adhesives of the invention adhere well to both polar and non-polar substrates.

### SUMMARY OF THE INVENTION

The present invention is directed to an aqueous pressure sensitive adhesive composition containing a vinyl ester-ethylene copolymer having a high level of ethylene. The copolymer may also contain at least one non-carboxyl containing functional monomer.

The invention is also directed to materials that have the pressure sensitive adhesive composition directly deposited on them, and also to a labeled substrate that has adhered thereto a material having the pressure sensitive composition on its surface.

The invention is further directed to a process for producing the ethylene/vinyl ester copolymer.

### DETAILED DESCRIPTION OF THE INVENTION

The invention is directed to a pressure sensitive adhesive composition containing a copolymer of ethylene and vinyl ester monomer, having a high level of ethylene. The ethylene content of the copolymer is from 40 to 75 percent by weight, preferably from 45 to 70 percent by weight, and more preferably from 50 to 70 percent by weight.

The vinyl ester monomer is present in the copolymer at from 5 to 60 percent by weight. Vinyl ester monomers include, for example, vinyl versatate, vinyl acetate, vinyl formate, vinyl propionate, vinyl butyrate, vinyl isobutyrate, vinyl valerate, vinyl 2-ethyl-hexanoate, and mixtures thereof. A preferred vinyl ester monomer is vinyl acetate.

The copolymer also contains from 0 to 20 percent by weight, and preferably from 0.5 to 15 percent by weight of one or more functional monomers that are not carboxyl-functional. Without the incorporation of the functional monomer, the copolymer is too low in tack to be useful as a pressure sensitive adhesive. Examples of functionalized monomers useful in the present invention include, but are not limited to, nitrogen functional monomers, alcohol functional monomers, and (meth)acrylates. Preferred monomers include N-methylol acrylamide, (meth)acrylamide, hydroxyethyl acrylate, hydroxypropyl acrylate, hydroxybutyl acrylate, acrylamidopropyl sulfonate (AMPS), 2-acrylamido-2-methylpropane sulfonic acid, ammonium acrylamidylpropyl sulfonate, alkyl ethers of N-methyl(meth)acrylamide such as isobutoxy methacrylamide, acrylonitrile, and dimethylacrylamide, as well as salts thereof. Especially preferred functionalized monomers are N-methylol acrylamide (NMA) and (meth)acrylamide. The functional monomer(s) are incorporated into the copolymer without any significant loss of ethylene content, and provide improvements in both peel and shear properties of the PSA.

Carboxyl-functional monomers, such as acrylic acid and methacrylic acid are absent from the copolymer. It has been found that optimum adhesive properties can be achieved without the use of carboxyl-functional monomers.

Other non-functional ethylenically unsaturated monomers may also be used to form the copolymer binder at a level of up to 20 weight percent based on the total monomer. These monomers can be used to obtain desirable copolymer properties in ways known in the art. Useful monomers include, but are not limited to, styrenics, and unsaturated hydrocarbons. The total of all monomers in the copolymer adds up to 100 weight percent.

The emulsion process for producing the functional copolymers of the present invention is believed to be an important factor in obtaining the high level of ethylene incorporation, and the resultant desirable properties. While not being bound to any particular theory, it is believed that key factors in the process include polymerization at medium pressure, a small initial charge, and the use of the proper stabilizer. The reaction is carried out at a medium pressure of between 500 and 1500 psi. Lower pressure reactions have been found to incorporate less than about 45 percent by weight of ethylene into the ethylene/vinyl ester copolymer. High-pressure reactions result in a copolymer having more than 85 percent by weight ethylene. Such a high ethylene level may result in high crystallinity, which may reduce the tack of the resultant copolymer.

The emulsion polymer is formed using a stabilizer. The stabilizer can be either a surfactant or a colloid. The surfactant can be any surfactant known in the art. Preferably the surfactant is an anionic or non-ionic surfactant, or a mixture of said surfactants. Preferred non-ionic surfactants include non-alkoxyphenol-based surfactants, and polyvinyl alcohol. Preferably the surfactant is an ethoxylated alcohol. Preferred anionic surfactants are sulfonate or sulfate salts, most preferably sulfosuccinic acid derivatives.

Formation of the ethylene/vinyl ester emulsion polymer is facilitated by the use of a polymerizable stabilizer such as sodium vinyl sulfonate, vinyl phosphonic acid, acrylamido-2-methyl-1-propanesulfonic acid, and their salts and derivatives. Preferably, the polymerizable stabilizer is sodium vinyl sulfonate. The polymerizable stabilizer is incorporated into the polymer at from 0 to 5 percent by weight, preferably from 0.1 to 4 percent by weight, and most preferably from 0.5 to 3 percent by weight, based on the weight of the copolymer.

The emulsion polymer can be formed by a surfactant-free process using a polymeric colloid stabilizer. The colloid stabilizer may be formed in situ or added separately. By selecting a colloid stabilizer, as described above, the ethylene/vinyl ester polymer can be salt sensitive.

The initiator system is generally a redox pair, which is effective for lower temperature polymerizations. Redox pairs using persulfate, hydroperoxide, or peroxide oxidants along with a reductant are preferred. Hydroperoxides, and most preferably tert-butyl hydroperoxide (tBHP) may be used as oxidants in the redox pair to initiate polymerization. One particularly preferred initiator system comprises a hydroperoxide oxidant, in amounts of between 0.05 and 3 percent by weight, preferably 0.1 and 1 percent by weight based on the total amount of the emulsion, and a sulfur-based reductant in amounts of 0.05 to 3 percent by weight, preferably 0.1 to 1 percent by weight, based on the total amount of the emulsion. One preferred reductant is sodium formaldehyde sulfoxylate. The redox initiator system is slow-added during the polymerization.

To control the generation of free radicals, a transition metal often is incorporated into the redox system, and such metals include an iron salt, e.g., ferrous and ferric chloride and ferrous sulfate. The use of transition metals and levels of addition to form a redox system for polymerization media is well-known.

The polymerization is carried out at a pH of between 2 to 9. Chain transfer agents, like mercaptans, chloroform, methylene chloride and trichloroethylene, can also be added in some cases.

The ethylene/vinyl ester emulsion polymer is prepared using the following process. A small initial charge is added to a reactor, preferably from 0 to 10 percent based on the weight of polymer. The initial charge and slow add contain an amount of stabilizer sufficient to maintain emulsion stability, preferably from 0.5 to 10 percent by weight based on the weight of the total monomer. Ethylene pressure is maintained in the reactor at a pressure above 500 psi, preferably above 1100 psi, and most preferably from 700 to 1500 psi, from before initiation until after the reaction is complete. The conversion is kept high throughout the reaction by sufficient agitation, addition of adequate amounts of the redox pair, and a temperature high enough to ensure rapid conversion, yet low enough to encourage ethylene solubility in the water. The temperature of the reaction is maintained at from 25 to 100° C., and preferably at from 50 to 80° C. A slow monomer feed is used, lasting from 1 to 10 hours, preferably from 2 to 6 hours and most preferably from 3 to 5 hours.

The polymerization reaction is generally continued until the residual vinyl ester monomer content is below about 1 percent, preferably less than 0.2 percent. The completed reaction product is then allowed to cool to about room temperature while sealed from the atmosphere.

The emulsions are produced and used at relatively high solids contents of between 35 to 60 percent, preferably 45 to 55 percent, although they may be diluted with water as desired. Preferably the viscosity of the emulsion at 50 percent solids and 25° C. is less than 5,000 cP, more preferably less than 2,000 cP., and most preferably less than 1,000 cP.

The particle size of the latex can be regulated by the quantity of nonionic or anionic emulsifying agent or protective colloid employed. To obtain smaller particle size, greater amounts of emulsifying agents are used. As a general rule, the greater amount of the emulsifying agent employed, the smaller the average particle size.

The polymer formed from the emulsion process has a Tg of from −25° C. to −65° C., preferably −30° C. to −60° C., and most preferably −35° C. to −55° C.

The functional ethylene/vinyl ester copolymer provides most of the properties required in a PSA. For instance, surprisingly the copolymer exhibits excellent tack, even without the addition of a tackifier. Generally, the copolymer is combined with adjuvants into a stable pressure sensitive adhesive formulation. The adjuvants enhance the adhesion performance of the formulation. Adjuvants useful in the formulation include, but are not limited to, thickeners, tackifiers, crosslinking agents, fillers, plasticizers. The pressure sensitive adhesive formulation has low viscosity of less than 5,000 cP and preferably less than 2,000 cP at 25° C.

The aqueous-based pressure sensitive adhesive formulation can be applied to a material by means known in the art, such as by spray, brush, coater, dipping, squeegee, or other means known in the art. The PSA formulation may be used on a fast-moving coater. Materials to which the PSA formulation is typically applied include, but are not limited to, porous materials such as paper, textiles, leather, wood; and to non-porous materials such as plastic films, metals, polyethylene terephthalate, polyols. The PSA-coated materials are useful as labels for film and graphics, prime labels, decals, repositionable notes, permanent paper labels, tape, electrical tape, and industrial tape.

Labels containing the PSA may be easily applied to a substrate with light pressure. Since the PSA of the present invention is based on ethylene/vinyl ester, rather than on acrylics, the PSA provide improved performance on low surface energy substrates, including polyethylene and polypropylene films.

The products produced with the PSA of the present invention offer advantages over current technology, since they can be produced with low-cost raw materials and prepared by an economical emulsion process.

The following examples are presented to further illustrate and explain the present invention and should not be taken as limiting in any regard.

### EXAMPLES 1-10

### Functionalized Copolymers and Control

A 10 liter reactor was charged with 2896.43 g water, 2.14 g TERGITOL 15S5, 9.65 g TERGITOL 15S40, (70% solution), 75.60 g sodium vinyl sulfonate (25% solution), 10.07 g ferrous sulfate heptahydrate (1% solution), 10.07 g VERSENE (1% solution), 1.01 g sodium formaldehyde sulfoxylate, 0.33 g sodium acetate and 100.74 g vinyl acetate. The pH of the initial charge (minus vinyl acetate) was adjusted to pH 4 with phosphoric acid. The reactor was then purged with nitrogen and with ethylene and heated with agitation to 50° C., then pressurized to 800 psi ethylene. Addition of a t-butyl hydroperoxide solution (406.17 g water and 83.92 g t-butyl hydroperoxide) and a buffered sodium formaldehyde sulfoxylate solution (406.17 g water, 74.75 g sodium formaldehyde sulfoxylate and 3.53 g sodium acetate) was commenced at a 2 hour addition rate. When temperature rise indicated initiation, the jacket temperature was increased to 70° C. and a slow addition of an emulsified monomer mix consisting of 579.24 g water, 23.06 g TERGITOL 15S5, 124.39 g TERGITOL 15S40 (70% solution), 152.81 g AEROSOL A102 (31% solution), 23.30 g AEROSOL OT-75 (75% solution), 151.11 g sodium vinyl sulfonate (25% solution), 1.15 g sodium acetate, X g of functional monomer (see Table 1) and 1958.08 g vinyl acetate was begun at a 3.5 hour rate. When the temperature reached 65° C., the ethylene pressure was increased to 1100 psi and set for the automatic mode where pressure would be maintained at 1100 psi during the course of the slow addition. The jacket was then lowered to 60° C. and oxidant and reductant rates were adjusted manually to maintain a reaction temperature of 65° C. The jacket temperature was lowered as needed to control temperature if oxidant and reductant rates approached minimum practical rates. Fifteen minutes after the end of the emulsified monomer mix slow addition, the ethylene valve was shut and the ethylene pressure allowed to decrease. The t-butyl hydroperoxide and sodium formaldehyde sulfoxylate solutions were fed until the ethylene pressure leveled out.

The contents were then cooled to 55° C. and transferred to a 20 liter vessel to remove any unreacted ethylene. The following solutions were added to reduce the amount of unreacted monomer: 3.53 g t-butyl hydroperoxide in 14.36 g water and 3.53 g sodium formaldehyde sulfoxylate in 14.36 g water.

Measurement of the ethylene content was done by C-13 NMR. Table 1 gives the compositions of the polymers in Examples 1-10. NMA is 48% solids, acrylamide is 50% solids, hydroxyethyl acrylate is 100% solids and ammonium AMPS is 50% solids.

TABLE 1
EVA Polymer Composition

| | Compositions in Parts (g) | | |
|---|---|---|---|
| | | Vinyl | |
| Example | Ethylene | Acetate | |
| # | % | % | % Functional Monomer (X g) |
| 1 | 56 | 44 | None (0 g) |
| 2 | 58 | 41.5 | 0.5 N-Methylol Acrylamide (61.12 g) |
| 3 | 59 | 37 | 4.0 N-Methylol Acrylamide (486.85 g) |
| 4 | 54 | 42 | 4.0 N-Methylol Acrylamide (486.85 g) |
| 5 | 59 | 40.5 | 0.5 Acrylamide (53.62 g) |
| 6 | 54 | 42 | 4.0 Acrylamide (428.94 g) |
| 7 | 57 | 42 | 1.0 Hydroxyethyl Acrylate (53.62 g) |
| 8 | 50 | 47 | 3.0 Hydroxyethyl Acrylate (160.85 g) |
| 9 | 57 | 42.5 | 0.5 Ammonium Acrylamidylpropyl |
| | | | Sulfonate (53.62 g) |
| 10 | 55 | 41 | 4.0 Ammonium Acrylamidylpropyl |
| | | | Sulfonate (428.94 g) |

Table 2 gives the properties of the emulsions produced in Examples 1-10.

TABLE 2
EVA Emulsion Properties

| Example # | Comments | % Solids | Viscosity cP | pH |
|---|---|---|---|---|
| 1 | No functionalized monomer | 49.0 | 75 | 5.7 |
| 2 | | 49.8 | 66 | 5.8 |
| 3 | Initial E pressure 1100 psi | 50.1 | 155 | 5.5 |
| 4 | | 49.5 | 360 | 5.6 |
| 5 | | 50.8 | 78 | 6.3 |
| 6 | | 48.9 | 538 | 5.9 |
| 7 | | 49.8 | 64 | 6.2 |
| 8 | | 48.5 | 82 | 5.7 |
| 9 | | 50.1 | 72 | 5.4 |
| 10 | | 49.3 | 66 | 5.4 |

The EVA emulsions were coated onto a silicone release liner and dried in a 250° C. oven for 10 minutes. The coatings were then transferred to a facestock film. Adhesion performance was evaluated with a 1 inch strip of the coated feedstock film. The adhesion was evaluated using the following test procedures:

Peel Test

180° Peel was tested using the method described by Pressure Sensitive Tape Council in PSTC-1. The test involves peeling the tape off a substrate at a 180 degree angle after application under relatively light pressure. Testing was done to allow 20 minutes and 24 hour contact of the adhesive with the test panel. The results are reported as the force required to remove the tape, measured in grams per inch width.

Shear Adhesion

Shear adhesion was measured according to PSTC-7 using a 2,000 gram mass at room temperature. The bonded area was 1 inch by 1 inch. The results are reported as the time required for the bond to fail.

The coating weight is dry coating weight in all examples, unless otherwise indicated.

Table 3 summarizes adhesion performance of these unformulated polymers on stainless steel panel and Table 4 provides adhesion data for high density polyethylene (HDPE). AF refers to “adhesive failure”.

TABLE 3
Adhesion Performance of EVA's Without Formulation
(Stainless Steel Panel)

| | | Bond Strength (g/in), 180° Peel | | | | 4 PSI |
|---|---|---|---|---|---|---|
| | Coat | | | 24 hrs, | Loop | shear |
| | Wt. | | | 95% RH, | Tack | (hours) |
| Ex. # | (#/r) | Initial | 24 hrs, RT | 100° F. | (oz/in²) | 1″ × 1″/2 kg |
| 1 | 12.6 | 7.3 AF | 4.7 AF | 3.3 AF | 1.0 | 0 |
| 2 | 12.9 | 40.5 AF | 52.0 AF | 2.0 AF | 3.8 | 26.38 |
| 3 | 12.4 | 647.0 AF | 712.0 AF | 7.0 AF | 3.4 | 55.81 |
| 4 | 12.3 | 573.3 AF | 635.0 AF | 1.0 AF | 3.2 | 96.40 |
| 5 | 12.2 | 29.0 AF | 36.3 AF | 1.7 AF | 2.3 | 10.14 |
| 6 | 12.0 | 136.5 AF | 465.0 AF | 9.0 AF | 2.3 | 22.75 |
| 7 | 12.4 | 16.0 AF | 33.0 AF | 7.7 AF | 0.5 | 5.82 |
| 8 | 12.8 | 140.7 AF | 714.0 AF | 8.3 AF | 3.2 | 15.77 |
| 9 | 12.5 | 16.0 AF | 49.0 AF | 10.0 AF | 3.6 | 6.32 |
| 10 | 12.5 | 31.3 AF | 47.7 AF | 10.0 AF | 4.0 | 0.03 |

TABLE 4
Adhesion Performance of EVA's Without Formulation
(HDPE)

Bond Strength (g/in),
180° Peel

| | Coating | | 24 hrs, 95% RH, |
|---|---|---|---|
| Example # | Weight (#/r) | Initial | 100° F. |
| 1 | 12.6 | 34.7 AF | 41.7 AF |
| 2 | 12.9 | 80.3 AF | 377 AF |
| 3 | 12.4 | 213.0 AF | 470 AF |
| 4 | 12.3 | 211.3 AF | 483 AF |
| 5 | 12.2 | 51.3 AF | 188 AF |
| 6 | 12.0 | 106.5 AF | 513.5 AF |
| 7 | 12.4 | 96.3 AF | 222 AF |
| 8 | 12.8 | 568.3 AF | 585 AF |
| 9 | 12.5 | 56.3 AF | 184.7 AF |
| 10 | 12.5 | 60.7 AF | 45 AF |

The EVA emulsions tested show pressure sensitive adhesive properties. Incorporation of a polar functional group improved the adhesion performance compared to the control that contains only ethylene and vinyl acetate. The NMA, acrylamide and hydroxyethyl acrylate-containing samples are superior to the control. The adhesive properties of the NMA-containing samples are remarkably good for unformulated compounds.

### EXAMPLES 11-15

### Varied Levels of NMA

Examples 11-15 were prepared using the process similar to that used for Examples 1-10. Results of testing are shown in Table 5. It was found that an optimum overall adhesion could be obtained by using ˜8% NMA in the EVA copolymer. Optimum NMA level can, of course, vary with formulation and process.

TABLE 5
Effects of NMA Level on EVA Adhesion
(Stainless Steel Panel - Without Formulation)

| | | | 24 hrs/95% | Shear |
|---|---|---|---|---|
| | NMA Monomer | Initial Peel | RH/100° F. | Resistance |
| Example # | Level (%) | (g/in) | (g/in) | (4 psi, hours) |
| 11 | 0.5 | 41 | 2 | 26 |
| 12 | 4 | 610 | 5 | 76 |
| 13 | 8 | 131 | 12 | 78 |
| 14 | 10 | 31 | 3 | 60 |
| 15 | 15 | 210 | 17 | 28 |

### EXAMPLE 16

### EVA Pressure Sensitive Adhesive Plus Thickener

The EVA polymer emulsions are normally combined with a thickener to improve the coatability of the pressure sensitive adhesives. The EVA emulsions (Examples 1, 4, 6, and 8) were combined with 0.50 pph of NOPCO DSX-3000, Cognis Corporation). These partially formulated products were all uniform and stable. More importantly, the viscosity increased dramatically for all of the functionalized EVA emulsions, which makes possible a coater-ready adhesive product. Viscosity was measured on a Brookfield viscometer with a #3 spindle at 20 rpm and 25° C.

The partially formulated samples were coated on a brown release liner. All of the thickened samples had good wettability. After drying in a 250° F. oven for 10 minutes, the coatings were transferred to 2 mil polypropylene film. After conditioning in constant temperature and humidity (CTH) room overnight, performance was evaluated on stainless steel panels. The functionalized EVA emulsions largely maintained the peel performance and shear adhesion, while the control remained a poor performer in adhesion evaluation. The results are provided in Table 6. The bond strength results are listed as percent of adhesive transferred (% T) or as adhesive failure (AF). When a percentage is not indicated for AF or T, the percentage is 100 percent. The symbol AF/T is used to mean that there was a mixed failure mode. AF is the best result, meaning that the adhesive remained on the polypropylene film, with the stainless steel/adhesive bond breaking, and no adhesive left on the stainless steel panel. If adhesive was transferred to the panel, the lower the amount of transfer, the better.

TABLE 6
Adhesion Performance of Fresh Coating with Thickener
(SS Panel)

| | | | | | Bond Strength (g/in), | | | | |
|---|---|---|---|---|---|---|---|---|---|
| | | | | | 180° Peel | | | | 4 PSI |
| | Base | Viscosity, cP | | Coat | | | 24 hrs, | Loop | Shear |
| Ex | Emulsion | | 48 hrs | Weight | | 24 hrs, | 95% RH, | Tack | (hours) |
| # | Ex. # | Initial | at RT | (#/r) | Initial | RT | 100° F. | (oz/in²) | 1″ × 1″/2 kg |
| 16A | 1 | 2945 | 2985 | 11.4 | 6.0 T | 5.0 T | 7.7 AF | 0 | 0.06 |
| 16B | 4 | 2710 | 2805 | 10.7 | 323.7 AF | 227.7 | 1.3 AF/T | 1 | 129.7 |
| | | | | | | 100% AF | | | |
| 16C | 6 | 1275 | 1335 | 10.9 | 294.3 AF | 258.0 AF | 8.3 | 0 | 131.9 |
| | | | | | | | AF/edge T | | |
| 16D | 8 | 1745 | 1815 | 11.3 | 169.7 | 4.7 | 9.0 | 0 | 1.81 |
| | | | | | 85% AF, | 100% T | 100% AF | | |
| | | | | | 15% T | | | | |

### EXAMPLE 17

### EVA Pressure Sensitive Adhesive Plus Thickener and Crosslinker

A fully formulated pressure sensitive adhesive will often include a crosslinking agent to improve the adhesion characteristics. To the partial formulations evaluated in Example 16, 0.29 pph BACOTE-20, a zirconium-based complex (Magnesium Elektron, Inc.) was added as the crosslinker. All formulations again were stable and uniform. The only exception was the formulation that contained an EVA control that was not functionalized. Results are in Table 7, below.

TABLE 7
Composition of Formulation Containing Crosslinker

| Ingredients: [parts] | 17A | 17B | 17C | 17D |
|---|---|---|---|---|
| Example 1 | 100 | — | — | — |
| Example 4 | — | 100 | — | — |
| Example 6 | — | — | 100 | — |
| Example 8 | — | — | — | 100 |
| NOPCO DSX-3000 | 0.49 | 0.49 | 0.50 | 0.56 |
| BACOTE - 20 | 0.29 | 0.29 | 0.29 | 0.29 |

Viscosity [cP], spindle #3 at 20 RPM, 4oz short jar

| | | | | |
|---|---|---|---|---|
| Initial | 4040/foaming | 2720 | 1295 | 1950 |
| 1 week at RT | 4900 | 2890 | 1555 | 2020 |
| | very foaming | | | |

The formulation using the emulsion of Example 1 was unable to be coated on release liner due to a foaming problem. Other formulated samples were coated on brown release liner with good wettability, dried, and transferred to 2 mil polypropylene film. The coated samples were placed in CTH room overnight for conditioning. The adhesion performance was then evaluated on both stainless steel and HDPE panels (Tables 8 and 9, respectively).

TABLE 8
Adhesion Performance of EVA Formulation with Crosslinker
(SS Panel)

| | | Bond Strength (g/in), 180° Peel | | | | 4 PSI Shear |
|---|---|---|---|---|---|---|
| | C.W. | | | 24 hrs, | Loop Tack | (hours) |
| Example # | (#/r) | Initial | 24 hrs, RT | 95% RH, 100° F. | (oz/in²) | 1″ × 1″/2 kg |
| 17B | 11.0 | 214.7 AF | 292.7 AF | 19.7 AF | 0 | >176 |
| 17C | 11.2 | 129.7 AF | 184.0 AF | 12.7 AF | 2 | >740 |
| 17D | 11.0 | 370.3 AF/T | 626.3 AF | 5.3 AF | 4 | 6.02 |

TABLE 9
Adhesion Performance of EVA Formulation with Crosslinker
(HDPE Panel)

| | | Bond Strength (g/in), 180° Peel | | |
|---|---|---|---|---|
| | | | | 24 hrs, 95% RH, |
| Example # | C.W. (#/r) | Initial | 24 hrs, RT | 100° F. |
| 17B | 11.0 | 123.7 AF | 257.7 AF | 15.0 T |
| 17C | 11.2 | 77.0 AF | 231.0 AF | 4.0 T |
| 17D | 11.0 | 221.3 AF/T | 365.3 AF | 2.7 T |

### EXAMPLE 18

### Fully Formulated Pressure Sensitive Adhesive

Fully formulated pressure sensitive adhesives were prepared using an EVA emulsion, thickener, crosslinking agent, and tackifier. As shown in Table 10, the NMA-modified high ethylene EVA emulsion of Example 13 was formulated with 20 pph AQUATAC 6085 (Arizona Chemical), 0.5 pph NOPCO DSX 3000, and varying amounts of BACOTE 20 crosslinker (0 pph, 0.15 pph, 0.30 pph, and 0.60 pph). Tack, peel, humidity resistance, and shear adhesion were measured for formulations on stainless steel panels. Peel strength and humidity resistance were also measured on high-density polyethylene (HDPE) panels. A high shear adhesion was obtained with NMA-modified high ethylene EVA base formulations.

All formulations were stable and without grits. The samples were coated on thin brown paper release liner and dried in the oven at 250° F. for 10 minutes. The adhesives were then transfer-coated to 2-mil polypropylene face stock and stored in the CTH room for 24 hours for conditioning.

TABLE 10
Formulations of EVA Modified with 8% NMA

| | Example 13 | AQUATAC | NOPCO DSX 3000 | BACOTE | | |
|---|---|---|---|---|---|---|
| Example # | (g) | 6085 (g) | (g) | 20 | pH | Viscosity (cP) |
| 18A | 100.01 | 20.00 | 0.5400 | 0 | 5.09 | 95 |
| 18B | 100.15 | 20.02 | 0.5538 | 0.3203 | 6.72 | 100 |
| 180 | 100.02 | 20.20 | 0.5188 | 0.1830 | 6.15 | 85 |
| 18D | 100.01 | 20.04 | 0.5203 | 0.631 | 7.05 | 110 |

The fully formulated PSAs were evaluated for shear resistance, peel and humidity resistance. All tests were done on stainless steel. Only peel and humidity resistance evaluations were done on HDPE in addition to the stainless steel. The adhesion results are summarized in Table 11. The adhesion data show that the formulation responded to the addition of crosslinker. Without crosslinker, the humidity resistance was poor on stainless steel. The addition of BACOTE 20 improved humidity resistance on stainless steel. The humidity resistance generally increased with higher BACOTE 20 concentration in the formulation. On HDPE, however, the humidity resistance of NMA-EVA was excellent under most crosslinking conditions.

TABLE 11
Adhesion Performance of Fully Formulated NMA-EVA with Different Levels of Crosslinker

| | | | | | | Hr Peel | | | | | |
|---|---|---|---|---|---|---|---|---|---|---|---|
| | | Initial | | 24 Hr Peel | | (100° F./ | | 1 Wk | | 1 Wk (100° F./ | |
| | | (20 min) | | (RT) | | 95% RH) | | (RT) | | 95% RH) | |
| Example # | Shear (Hrs) | SS | HDPE | SS | HDPE | SS | HDPE | SS | HDPE | SS | HDPE |
| 18A | 1.54 | 259.3 | 553.7 | 486.3 | 879.7 | 31.3 | 630.3 | 617 | 806.5 | 79.5 | 252.3 |
| | | AF | 10% T | AF | 95% T | AF | 95% T | AF | 100% T | 20% T | 100% T |
| 18B | 2.29 | 403 | 956 | 555 | 451 | 616 | 771 | 619 | 536 | 345 | 381 |
| | | AF | 50% T | AF | AF | 5% T | 50% T | AF | AF | 5% T | 80% T |
| 18C | 2.75 | 315.3 | 228 | 536 | 312 | 199.3 | 678 | 790.7 | 590.7 | 76.3 | 110 |
| | | AF | AF | AF | AF | AF | 5% T | AF | AF | 20% T | 95% T |
| 18D | 6.18 | 232.3 | 148.7 | 670 | 412.7 | 574.3 | 732.7 | 717 | 574.3 | 319.7 | 409.7 |
| | | AF | AF | AF | AF | AF | 75% T | AF | AF | 50% T | 95% T |

Similarly, an increase in BACOTE 20 in the formulation brought about an increase in peel strength on stainless steel after aging at room temperature as well as a direct boost in shear resistance. On the other hand, inverse relationships existed between the BACOTE 20 and both initial peel strength and peel strength on HDPE after aging at room temperature. A decline in initial peel strength was the result of added crosslinker; likewise for peel strength on HDPE after aging at room temperature.

### EXAMPLE 19

### EVA With Different Functional Monomers

High ethylene EVA emulsions containing acrylamide and dimethylacrylamide as the functional monomer were investigated. When the unformulated emulsions were tested, the acrylamide and dimethylacrylamide-modified EVA emulsions were superior to the NMA-modified emulsion in tack and, subsequently, initial peel strength. Full formulations were then made with acrylamide-modified (Example 19A) and dimethylacrylamide-modified (Example 19B) high ethylene EVA bases using the same optimized levels of components as in Example 17 (Table 7). Formulations are shown in Table 12. Peel strength and humidity resistance on both SS and HDPE are summarized in Table 13. “Shadowing”, or ghosting, as used herein, refers to results seen on a stainless steel panel in which a haze layer is noticed on the stainless steel panel after the adhesive label is peeled off.

TABLE 12
Formulations of EVA Modified with Acrylamide and Dimethylacrylamide

| | AQUATAC | NOPCO DSX | | | |
|---|---|---|---|---|---|
| | 6085 | 3000 | BACOTE 20 | 4% | |
| Example | (Thickener) | (Thickener) | (Crosslinker) | Acrylamide | 4% |
| # | pph Polymer | pph Polymer | pph Polymer | EVA | Dimethylacrylamide |
| 19A | 25 | 0.6 | 0.45 | 100 | — |
| 19B | 25 | 0.6 | 0.45 | — | 100 |

TABLE 13
Adhesion Performance Evaluation for Optimized Formulations

| | | Loop | Initial | | 24 Hr Peel | | 24 Hr Peel | | | | 1 Wk | |
|---|---|---|---|---|---|---|---|---|---|---|---|---|
| | Shear | Tack | (20 min) | | (RT) | | (100° F./95% RH) | | 1 Wk (RT) | | (100° F./95% RH) | |
| Example # | (Hrs) | (oz/sq inch) | SS | HDPE | SS | HDPE | SS | HDPE | SS | HDPE | SS | HDPE |
| 19A | 45.55 | 11.2 | 476.33 | 260 | 404.67 | 277.33 | 12.33 | 444.67 | 353.33 | 229.67 | 11.33 | 391.67 |
| | | | AF | AF | AF | AF | AF | AF | AF | AF | AF | 75% T |
| | | | | | | | | | (shadow) | | | |
| 19B | 2.59 | 7.2 | 437.33 | 463 | 481.33 | 447 | 2.67 | 11.67 | 441.67 | 393.67 | 9.67 | 7.67 |
| | | | 5% T | 20% T | AF | 20% T | AF | 95% T | AF | 5% T | AF | 100% T |
| | | | | | (shadow) | | (shadow) | | (shadow) | | (shadow) | |

High shear, tack, and initial peel were displayed by Sample 19A, the formulation with the acrylamide-modified high ethylene EVA base. High tack and initial peel but slightly low shear resistance were found with the dimethylacrylamide-modified base.

### EXAMPLE 20

### EVA With High Crosslinker Formulations

Previous results had indicated that increasing crosslinker levels led to a corresponding improvement in humidity resistance on both substrates (SS and HDPE). Therefore, formulations with 0.8, 1.0, and 1.2 parts crosslinker per hundred parts base polymer were made (Tables 14 and 16). Testing for the high crosslinker formulations with the acrylamide-modified and dimethylacrylamide-modified bases yielded results shown in Tables 15 and 17 respectively.

TABLE 14
High Crosslinker Formulations of EVA
Modified with Acrylamide

| | 4% Acrylamide | AQUATAC | NOPCO | |
|---|---|---|---|---|
| Example # | EVA | 6085 | DSX 3000 | BACOTE 20 |
| 20A | 100 | 25 | 0.6 | 0.8 |
| 20B | 100 | 25 | 0.6 | 1.0 |
| 20C | 100 | 25 | 0.6 | 1.2 |

TABLE 15
Adhesion Performance Evaluation of Acrylamide-EVA with Higher Crosslinking

| | | | | | | | 24 Hr Peel | |
|---|---|---|---|---|---|---|---|---|
| | | Loop | Initial | | 24 Hr | | (100° F./ | |
| | Shear | Tack | (20 min) | | Peel (RT) | | 95% RH) | |
| Example # | (Hrs) | (oz/sq inch) | SS | HDPE | SS | HDPE | SS | HDPE |
| 20A | 156 | 5.3 | 572.67 | 216.33 | 610 | 336.33 | 180 | 452.33 |
| | | | AF | AF | AF | AF | AF | AF |
| 20B | 235 | 2 | 575.67 | 259.67 | 593.33 | 310 | 114.67 | 488.33 |
| | | | AF | AF | AF | AF | AF | AF |
| 20C | 433 | 4.5 | 621 | 282 | 617 | 292.33 | 180.67 | 417.67 |
| | | | AF | AF | AF | AF | AF | AF |

TABLE 16
High Crosslinker Formulations of EVA Modified
with Dimethylacrylamide

| | 4% | | | |
|---|---|---|---|---|
| | Dimethylacrylamide | AQUATAC | NOPCO | |
| Example # | EVA | 6085 | DSX 3000 | BACOTE 20 |
| 20D | 100 | 25 | 0.6 | 0.8 |
| 20E | 100 | 25 | 0.6 | 1.0 |
| 20F | 100 | 25 | 0.6 | 1.2 |

TABLE 17
Adhesion Performance Evaluation of Dimethylacrylamide-EVA Higher Crosslinking

| | | Loop | Initial | | 24 Hr | | 24 Hr Peel | |
|---|---|---|---|---|---|---|---|---|
| | Shear | Tack | (20 min) | | Peel (RT) | | (100 F./95% RH) | |
| Example # | (Hrs) | (oz/sq inch) | SS | HDPE | SS | HDPE | SS | HDPE |
| 20D | 4.97 | 5.5 | 430 | 337 | 485.67 | 502.33 | 41 | 157 |
| | | | (shadow) | AF | AF | AF | AF (shadow) | 80% T |
| | | | AF | | (shadow) | | | |
| 20E | 6.25 | 5.8 | 380.67 | 415.67 | 496 | 552.33 | 140.67 | 205.33 |
| | | | (shadow) | AF | AF | 5% T | 5% T | 90% T |
| | | | AF | | (shadow) | | | |
| 20F | 5.69 | 7.25 | 410 | 384.33 | 477.33 | 427.67 | 133.67 | 280 |
| | | | (shadow) | AF | AF | AF | AF (shadow) | 80% T |
| | | | AF | | (shadow) | | | |

The increase in BACOTE 20 crosslinker in the formulation did improve the humidity resistance. An improvement in peel strength after 24 hours in humid conditions for both bases was also found. Higher crosslinker levels also have led to a higher shear adhesion in general. Acrylamide-EVA samples have much higher shear adhesion than dimethylacrylamide-EVA. At certain crosslinker levels, acrylamide-EVA reached over 100 hours in 4 psi shear test.

### EXAMPLES 21-23

### Lower Ethylene Levels

Examples 21-23 were prepared using the process similar to that used for Examples 1-10. Results of testing for these Examples is shown in Table 18. The level of ethylene in the copolymers was at 40 percent by weight. The functional monomers used were acrylic acid (comparative) and hydroxyethyl acrylate. The Tg's are in the −30 to −32° C. range

Example 21 (comparative) was an EVA copolymer with 0.15 weight percent of acrylic acid. The emulsion was 54.3 percent solids, had a pH of 4.8, and a viscosity at 25° C. of 294 cP.

Example 22 was an EVA copolymer with 0.15 weight percent of hydroxyethyl acrylate. The emulsion was 54.1 percent solids, had a pH of 5.0, and a viscosity at 25° C. of 234 cP.

Example 23 (comparative) was an EVA copolymer with 0.15 weight percent of acrylic acid. The emulsion was 52.3 percent solids, had a pH of 4.7, and a viscosity at 25° C. of 130 cP.

TABLE 18
Adhesion Performance of EVA Containing Acrylic Acid or HEA
(1 mil coating)

| | Initial peel | | 24 hr Peel | | Shear | Loop |
|---|---|---|---|---|---|---|
| Example | SS | HDPE | SS | HDPE | (4 psi, Hrs) | Tack (oz/sq in) |
| 21 | 799.3 | 340.3 | 963 | 489 | 2.04 | 17.5 |
| | AF | AF | 80% AT | AF | | |
| 22 | 669.7 | 319 | 833 | 474.5 | 1.6 | 11.4 |
| | 5% AT | AF/zipper | 20% AT | AF/zipper | | |
| 23 | 846.7 | 499.7 | 856 | 565 | 1.05 | 17.5 |
| | AF | AF | 5% AT | AF | | |

Note:
AF = Adhesive Failure;
AT = Adhesive Transfer

What is claimed is:

1. An aqueous pressure sensitive adhesive composition comprising an emulsion copolymer comprising
a) from 40 to 75 percent by weight of ethylene units;
b) from 5 to 60 percent by weight of vinyl ester monomer units; and
c) from 0 to 20 percent by weight of at least one functional monomer unit, wherein said functional monomer is not a carboxyl-functional monomer; and
d) from 0 to 20 percent by weight of at least one non-functional monomer unit;
wherein the sum of all monomer percentages adds up to 100 weight percent, and wherein said copolymer is free of carboxyl functional monomer units.

2. The aqueous composition of claim 1 wherein said emulsion copolymer comprises 45 to 70 percent by weight of ethylene.

3. The aqueous composition of claim 1 wherein said emulsion copolymer comprises 50 to 70 percent by weight of ethylene.

4. The aqueous composition of claim 1 wherein said emulsion copolymer comprises 55 to 70 percent by weight of ethylene.

5. The aqueous composition of claim 1 wherein said vinyl ester monomer units comprise vinyl acetate.

6. The aqueous composition of claim 1 wherein said functional monomer comprises N-methylol acrylamide, (meth)acrylamide, or a mixture thereof.

7. The aqueous composition of claim 1 wherein said functional monomer unit comprises from 0.5 to 15 percent by weight of the copolymer.

8. The aqueous pressure sensitive composition of claim 1 further comprising one or more adjuvants selected from the group consisting of tackifiers, thickeners, crosslinking agents, fillers.

9. A label or tape comprising a material having directly deposited thereon an aqueous pressure sensitive adhesive composition comprising an emulsion copolymer comprising
a) from 40 to 75 percent by weight of ethylene units;
b) from 5 to 60 percent by weight of vinyl ester monomer units; and
c) from 0 to 20 percent by weight of at least one functional monomer unit, wherein said functional monomer is not a carboxyl-functional monomer,
and wherein said copolymer is free of carboxyl functional monomer units.

10. The label or tape of claim 8 wherein said material comprises paper, textile, leather, wood, polymer films, or metal.

11. A labeled substrate comprising a substrate having directly adhered thereon an adhesive label, wherein said label has directly coated thereon an aqueous pressure sensitive adhesive composition comprising an emulsion copolymer comprising
a) from 40 to 75 percent by weight of ethylene units;
b) from 5 to 60 percent by weight of vinyl ester monomer units; and
c) from 0 to 20 percent by weight of at least one functional monomer unit, wherein said functional monomer is not a carboxyl-functional monomer,
and wherein said copolymer is free of carboxyl functional monomer units.

12. A process for producing an aqueous pressure sensitive adhesive composition comprising
a) forming an initial charge comprising from 0 to 10 percent by weight monomer and a stabilizer level of from 0.5 to 10 percent by weight, based on the weight of the emulsion copolymer;
b) maintaining an ethylene concentration of above 500 psi;
c) slowly adding a monomer feed over a period of from 1 to 10 hours, and at a reaction temperature of from 25 to 100° C., producing a copolymer having at least 40 to 75 percent by weight of ethylene units, 5 to 60 percent by weight of vinyl ester monomer units; and free of carboxyl functional monomer units; and
d) combining said copolymer with at least one adjuvant selected from the group consisting of thickeners, tackifiers, crosslinking agents, fillers and plasticizers to form an aqueous pressure sensitive adhesive compositon.
